(19) United States
(12) Patent Application Publication
(10) Pub. No.: US 2025/0272877 A1
(43) Pub. Date: Aug. 28, 2025

(54) CAMERA PARAMETER ESTIMATING APPARATUS AND PROGRAM PRODUCT

(71) Applicant: DENSO CORPORATION, Kariya-city (JP)

(72) Inventors: Atsushi YOSHIHARA, Kariya-city (JP); Kenji OKANO, Kariya-city (JP); Hiroaki MARUNO, Kariya-city (JP); Kosuke AKITA, Kariya-city (JP)

(21) Appl. No.: 19/063,868

(22) Filed: Feb. 26, 2025

(30) Foreign Application Priority Data
Feb. 28, 2024 (JP) 2024-029069

(51) Int. Cl. G06T 7/80; G06T 7/62; G06V 10/74

(52) U.S. Cl. CPC G06T 7/80; G06T 7/62; G06V 10/761; G06V 2201/07

(57) ABSTRACT

In a parameter estimating apparatus, a marker identifier compares, for each target marker in an image captured by a camera, x- and y-coordinates of each characteristic point in a front-view coordinate system with true x- and y-coordinates of the corresponding characteristic point in the front-view coordinate system to accordingly determine whether a detection accuracy of each characteristic point is lower than a reference detection-accuracy requirement. The marker identifier identifies, as a low-accuracy target marker, a selected target marker from the target markers upon determination that the detection accuracy of at least one characteristic point arranged on the selected target marker is lower than the reference detection-accuracy requirement. A parameter estimator estimates at least one parameter of the camera in accordance with the x- and y-coordinates of each characteristic point arranged on one or more remaining target markers included in the image other than the low-accuracy target marker.

### CROSS REFERENCE TO RELATED APPLICATION

This application is based on and claims the benefit of priority from Japanese Patent Application No. 2024-029069 filed on Feb. 28, 2024, the disclosure of which is incorporated in its entirety herein by reference.

### TECHNICAL FIELD

The present disclosure relates to camera parameter estimating apparatuses and program products.

### BACKGROUND

A known technology performs surrounding monitoring around a vehicle and driving assistance of the vehicle in accordance with images captured by a camera mounted to the vehicle. Each image captured by the camera has a predetermined coordinate system defined thereon. The technology performs image-processing tasks based on the images captured by the camera to accordingly perform surrounding monitoring around the vehicle and driving assistance of the vehicle. To carry out surrounding monitoring around the vehicle and driving assistance of the vehicle, the coordinate system of each image is required to match, with high accuracy, an image coordinate system used by the image processing.

A proposed technology estimates camera parameters that define how a corresponding camera is mounted to a vehicle, which aims to ensure the matching accuracy between the coordinate system of each image captured by the camera and the image coordinate system used by the image processing.

For example, the technology disclosed in US Patent Publication No. 11341681 includes step A of correcting for distortions in an image captured by a camera. Additionally, the technology includes step B of detecting characteristic points of a calibration pattern, in other words, a target marker, included in the image captured by the camera, and step C of calculating the position and orientation of the camera based on the detected characteristic points.

The technology iterates steps A to C to accordingly estimate, based on a number of iterations of steps A to C so far or a confidence value determined in a latest iteration of step C, parameters of the camera with higher accuracy.

### SUMMARY

Low image quality of the camera mounted to, for example, a vehicle and/or mount error of the camera to the vehicle may result in reduction of the accuracy of detecting the characteristic points of the calibration pattern. The accuracy of the parameters estimated based on such low-accuracy characteristic points may therefore deteriorate strongly, so that even iterations of steps A to C may result in difficulty in improvement of the deteriorated accuracy. This may contribute to inappropriate estimation of the parameters of the camera.

From this viewpoint, the present disclosure provides camera parameter estimating apparatuses and program products, each of which aims to implement appropriate estimation of one or more parameters of a camera.

The present disclosure provides a camera parameter estimating apparatus for estimating, based on an image captured by a camera mounted to a physical object, at least one parameter of the camera. The image includes a plurality of target markers located at respective different positions of the image. Each target marker includes a plurality of characteristic points arranged thereon.

The camera parameter estimating apparatus includes a characteristic point detector configured to detect the characteristic points arranged on each target marker included in the image, and a coordinate calculator. The coordinate calculator is configured to perform, for each target marker, projective transformation of each characteristic point arranged on the corresponding target marker in a predetermined coordinate system to the corresponding characteristic point in a front-view coordinate system. The coordinate calculator is configured to calculate an x-coordinate and a y-coordinate of each characteristic point in the front-view coordinate system.

The camera parameter estimating apparatus includes a marker identifier. The marker identifier is configured to compare, for each target marker, the x- and y-coordinates of each characteristic point in the front-view coordinate system with true x- and y-coordinates of the corresponding characteristic point in the front-view coordinate system to accordingly determine whether a detection accuracy of each characteristic point is lower than a reference detection-accuracy requirement. The marker identifier is configured to identify, as a low-accuracy target marker, a selected target marker from the target markers upon determination that the detection accuracy of at least one characteristic point arranged on the selected target marker is lower than the reference detection-accuracy requirement.

The camera parameter estimating apparatus includes a parameter estimator. The parameter estimator is configured to estimate the at least one parameter of the camera in accordance with the x- and y-coordinates of each characteristic point arranged on one or more remaining target markers included in the image other than the low-accuracy target marker.

When a plurality of target markers located at respective different positions in an image captured by a camera mounted to a physical object, a detection accuracy of at least one characteristic point arranged on any target marker may decrease. If estimation of at least one parameter of the camera were carried out based on a target marker including the at least one low-accuracy characteristic point, the accuracy of the at least one parameter of the camera would decrease.

From the above viewpoint, the camera parameter estimating apparatus is configured to perform, for each target marker, projective transformation of each characteristic point arranged on the corresponding target marker in a predetermined coordinate system to the corresponding characteristic point in a front-view coordinate system.

The camera parameter estimating apparatus is configured to calculate an x-coordinate and a y-coordinate of each characteristic point in the front-view coordinate system.

The camera parameter estimating apparatus is configured to compare, for each target marker, the x- and y-coordinates of each characteristic point arranged on the corresponding target marker with true x- and y-coordinates of the corresponding characteristic point to accordingly determine whether a detection accuracy of each characteristic point is lower than a reference detection-accuracy requirement. Then, the camera parameter estimating apparatus is configured to identify, as a low-accuracy target marker, a selected target marker from the target markers upon determination that the detection accuracy of at least one characteristic point arranged on the selected target marker is lower than the reference detection-accuracy requirement.

That is, if each characteristic point arranged on each target marker included in the image are detected precisely, each of the x- and y-coordinates of each characteristic point in the front-view coordinate system arranged on each target marker substantially matches the corresponding one of the true x- and y-coordinates of the corresponding characteristic point in the front-view coordinate system.

In contrast, if there is a detection error of any characteristic point arranged on a target marker, the detection error of the characteristic point arranged on the target marker may cause a deviation of at least one of the x- and y-coordinates of each characteristic point arranged on the corresponding target marker from the corresponding at least one of the true x- and y-coordinates of the corresponding characteristic point to increase.

Accordingly, the camera parameter estimating apparatus, which compares, for each target marker, the x- and y-coordinates of each characteristic point in the front-view coordinate system with the true x- and y-coordinates of the corresponding characteristic point in the front-view coordinate system, makes it possible to precisely determine the detection accuracy of each characteristic point arranged on each target marker.

Additionally, the camera parameter estimating apparatus is configured to estimate the at least one parameter of the camera in accordance with the x- and y-coordinates of each characteristic point arranged on one or more remaining target markers included in the image other than the low-accuracy target marker.

This configuration therefore makes it possible to determine whether each target marker is suitable for being used in estimation of the at least one parameter of the camera, and to use only one or more target markers suitable for being used in estimation of the at least one parameter of the camera. This results in the accuracy of estimating the at least one parameter of the camera being higher.

Even if it is determined that the detection accuracy of at least one characteristic point included in some target markers is lower than the reference detection-accuracy requirement, the camera parameter estimating apparatus enables estimation of the at least one parameter of the camera using the one or more remaining target markers, making it possible to improve the estimation efficiency of the at least one parameter of the camera. This enables the at least one parameter of the camera to be more precisely estimated.

### BRIEF DESCRIPTION OF THE DRAWINGS

Other aspects of the present disclosure will become apparent from the following description of embodiments with reference to the accompanying drawings in which:

FIG. 1 is a plan view schematically illustrating a vehicle to which a plurality of cameras are mounted, and target markers;

FIG. 2 is a view schematically illustrating a configuration of a target marker;

FIG. 3 is a block diagram schematically illustrating functional blocks related to a parameter estimation function implemented by an ECU illustrated in FIG. 1;

FIG. 4 is a view schematically illustrating characteristic points detected in an image coordinate system;

FIG. 5 is a view schematically illustrating standardized characteristic points in the image coordinate system;

FIG. 6 is a view schematically illustrating characteristic points, which have been subjected to projective transformation, in a marker front-view coordinate system;

FIG. 7 is a view schematically illustrating that the coordinates of each characteristic point are deviated from true coordinates of the corresponding characteristic point;

FIG. 8 is a graph schematically illustrating an example of a relationship between a variable of a threshold coefficient and a size of each target marker; and

FIG. 9 is a flowchart schematically illustrating a parameter estimating routine.

### DETAILED DESCRIPTION OF EMBODIMENT

The following describes an exemplary embodiment of the present disclosure with reference to accompanying drawings. The exemplary embodiment embodies a camera parameter estimating apparatus that is used to calibrate one or more cameras of a vehicular camera system installed in a vehicle. The camera parameter estimating apparatus is configured to estimate one or more parameters of each camera, which show the installed state of the corresponding camera in the vehicle, during manufacturing of the vehicle. Estimating the one or more parameters of each camera enables the coordinate system of each image captured by the corresponding camera to match, with high accuracy, an image coordinate system used by image processing.

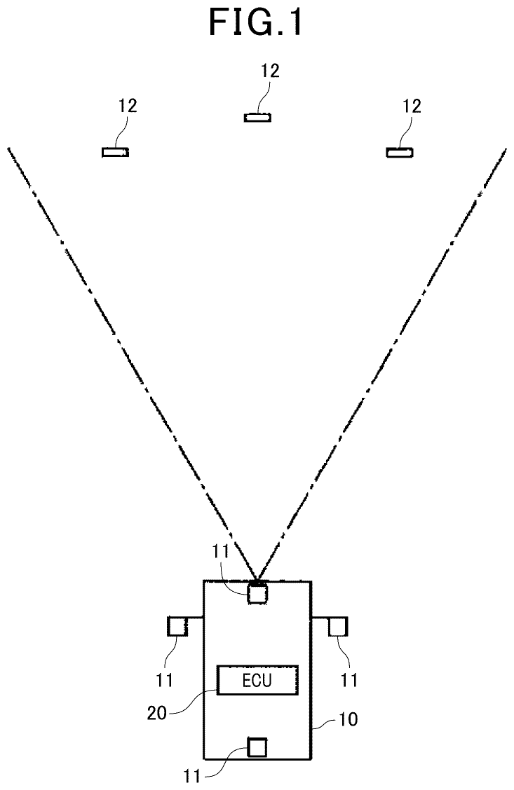

FIG. 1 illustrates a vehicle 10 to which cameras 11 are mounted and also illustrates target markers 12. Each camera 11 serves as a parameter estimation target. Each camera 11 mounted to the vehicle 10 is configured to capture images of a corresponding region located around the vehicle 10. For example, the cameras 11 are respectively mounted to the front side, rear side, left side, and right side of the vehicle 10.

Each camera 11 is comprised of a lens system and a complementary metal oxide (CMOS) image sensor or a charge-coupled device (CCD) image sensor as an imaging device. The image sensor is comprised of light-sensitive elements, each of which includes, for example, a CCD device or CMOS switch; the light-sensitive elements serve as pixels and are arranged in a two-dimensional array in both vertical and horizontal directions corresponding to the respective height direction and width direction of the vehicle 10. That is, the array of the pixels is configured as a predetermined number of columns by a predetermined number of rows. The two-dimensionally arranged pixels constitute a two-dimensional light receiving region, i.e., a two-dimensional pixel region, of the image sensor.

Each camera 11 has a predetermined image capture orientation, i.e., a viewing orientation in front of the corresponding camera 11, and has a predetermined angular field around the image capture orientation; the angular field extends two-dimensionally, i.e., extends in the vertical direction and the horizontal direction.

Each camera 11 is configured to successively capture an image, i.e., a frame image, of the predetermined angular field in front of the corresponding camera 11 based on incoming light being focused through the lens system on the two-dimensional pixel region thereof, so that each of the two-dimensionally arranged light-sensitive elements (pixels) receives a corresponding light component. Each frame image has, for example, a rectangular shape with each side in the horizontal direction being longer than each side in the vertical direction. Each pixel of each frame image therefore has the corresponding intensity or luminance level of the received light component as a luminance value of the corresponding pixel. Each frame image captured by each camera 11 has a predetermined two-dimensional coordinate system, i.e., a predetermined image coordinate system. The image coordinate system for each frame image captured by each camera 11 has an origin corresponding to the center thereof; the center of the image coordinate system corresponds to the center of the corresponding camera 11. The image coordinate system for each frame image captured by each camera 11 also has a horizontal passing through the origine and extending in the horizontal direction, and a vertical axis passing through the origin and extending in the vertical direction.

A method of performing calibration of each camera 11 uses a plurality of target markers 12 arranged at different positions in front of the corresponding camera 11; the target markers 12 are located within the angular field of the corresponding camera 11. For example, FIG. 1 illustrates three target makers 12 arranged in front of the vehicle 10. That is, three target markers 12 are arranged in front of the camera 11 mounted to the front side of the vehicle 12; the camera 11 mounted to the front side of the vehicle 10 will also be referred to as a front camera 11.

The three target markers 12 are arranged horizontally at predetermined respective distances away from the vehicle 10. Each target marker 12 stands on the floor of a factory in which the camera calibration is carried out.

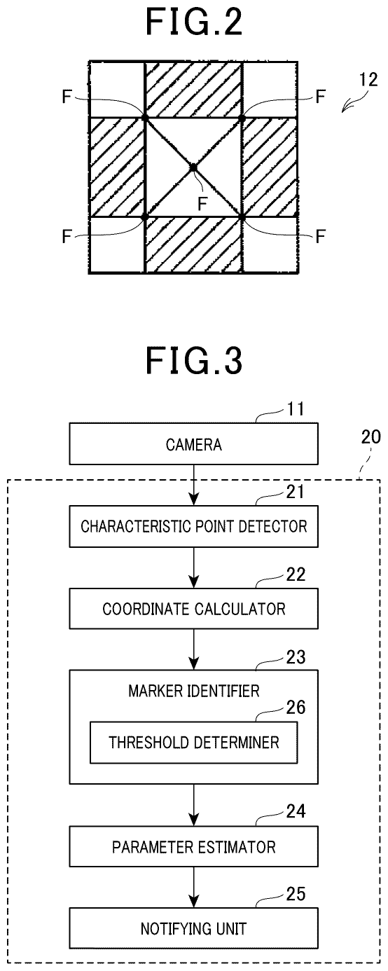

Each target marker 12 serves as a calibration marker used for calibration of cameras. Each target marker 12 has a front surface thereof, and has, for example, a predetermined graphic pattern, i.e., a figure pattern, as illustrated in FIG. 2. For example, the front surface of each target marker 12 illustrated in FIG. 2 has, for example, a rectangular or square shape. Each target marker 12 illustrated in FIG. 2 has, as the predetermined graphic pattern, a black and white grid pattern formed on the front surface and a cross mark formed on the black and white grid pattern. The black and white grid pattern is comprised of a white square or rectangular section located at the center of the front surface, which will also be referred to as a center section, and eight alternative black and white sections located to surround the center section. In particular, the eight alternative black and white sections include four white square or rectangular sections located at the respective corners of the black and white grid pattern, which will also be referred to as corner sections. The eight alternative black and white sections also include four rectangular black sections, each of which is located between a corresponding adjacent pair of the corner sections.

The cross mark is arranged in the center section.

The predetermined graphic pattern of each target marker 12 has defined a plurality of characteristic points, i.e., feature points, F, each of which serves as a landmark of the predetermined graphic pattern.

For example, the predetermined graphic pattern of each target marker 12 has five characteristic points F. Specifically, the center section has four corners, each of which is an intersection with the corresponding one of the corner sections and the corresponding two black sections, and the four corners of the center section respectively serve as four characteristic points F. Additionally, the center of the cross mark arranged in the center section of the black and white grid pattern serves as the remaining characteristic point F.

Each target marker 12 has any graphic pattern as long as a plurality of characteristic points F are defined on the graphic pattern. Preferably, each target marker 12 has any graphic pattern as long as at least four characteristic points F are defined on the graphic pattern.

The vehicle 10 includes an electronic control unit (ECU) 20 serving as a camera parameter estimating apparatus.

The ECU 20 includes a computer, more specifically, a processor, such as a microcomputer, that is comprised of, for example, a Central Processing Unit (CPU), a memory device including at least one of a Read-Only Memory (ROM) and a Random Access Memory (RAM), and one or more interfaces. The CPU is configured to execute programs stored in the memory device serving as a storage medium to implement various functions described later.

In particular, the ECU 20 is configured to be communicable with each camera 11 using wired or wireless connection therewith, and acquire images captured by each camera 11 to accordingly estimate the parameters of the corresponding camera 11 based on the images captured by the corresponding camera 11.

Next, the following describes a parameter estimation function implemented by the ECU 20 with reference to FIG. 3.

The ECU 20 includes a characteristic point detector 21, a coordinate calculator 22, a marker identifier 23, a parameter estimator 24, and a notifying unit 25. The marker identifier 23 includes, for example, a threshold determiner 26.

The characteristic point detector 21 is configured to detect the characteristic points F on each target marker 12 included in a frame image captured by each camera 11.

For the sake of simple description, the following describes a case where the characteristic point detector 21 detects the characteristic points F on each target marker 12 included in a frame image captured by the front camera 11.

For example, the characteristic point detector 21 is configured to detect, for each target marker 12 included in the frame image captured by the front camera 11, the five characteristic points F of the corresponding target marker 12 in accordance with the luminance levels of the respective pixels of the frame image; each of the five characteristic points F has corresponding coordinates in the image coordinate system defined for the frame image.

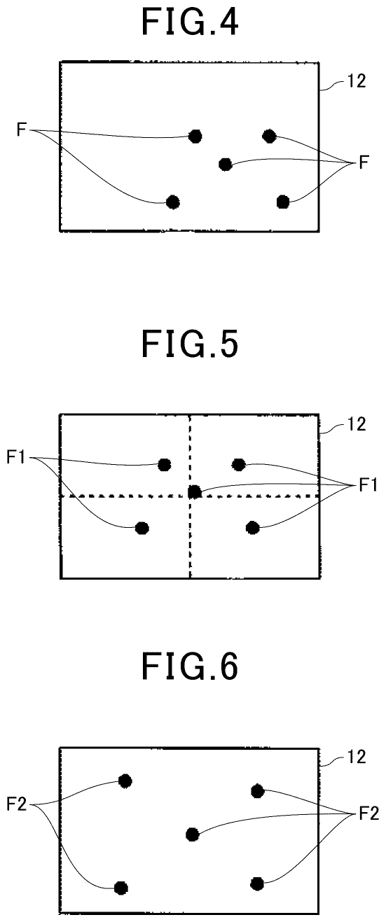

For example, FIG. 4 schematically illustrates, by black circular symbols, five characteristic points F in the image coordinate system. The horizontal axis of the image coordinate system is defined as an x-axis, and the vertical axis of the image coordinate system is defined as a y-axis, so that the coordinates of any characteristic point F in the image coordinate system can be referred to as (xᵢ, yᵢ).

The coordinate calculator 22 is configured to perform, for each target marker 12, projective transformation of the coordinates of each characteristic point F in the image coordinate system to accordingly calculate corresponding coordinates of the corresponding characteristic point F in a projective-transformed coordinate system, i.e., a two-dimensional marker front-view coordinate system. The marker front-view coordinate system for each target marker 12 is defined as a coordinate system viewed, i.e., observed, from the direct front of the corresponding target marker 12.

The coordinate calculator 22 according to the exemplary embodiment can be configured to perform, for each target marker 12, projective transformation, i.e., homography transformation, of the coordinates of the characteristic points F in the image coordinate system using homography matrix.

First, to perform homography transformation with high accuracy, the coordinate calculator 22 standardizes, for each target marker 12, the coordinates of each characteristic point F in the image coordinate system to accordingly acquire, for each target marker 12, a standardized characteristic point F1 in the image coordinate system (see FIG. 5).

For example, the coordinate calculator 22 changes, for each target marker 12, the center and scale of the coordinates of the characteristic points F, so that the coordinates of the characteristic points F of each target marker 12 have a mean of 0 and a standard deviation of 1. Specifically, the coordinate calculator 22 changes, for each target marker 12, the center and scale of the coordinates of the characteristic points F, so that
(I) The x-coordinates of the characteristic points F of each target marker 12 have a mean of 0 and a standard deviation of 1
(II) The y-coordinates of the characteristic points F of each target marker 12 have a mean of 0 and a standard deviation of 1

Next, the coordinate calculator 22 calculates the homography matrix used to perform projective transformation, i.e., homography transformation. In particular, to calculate, for each target marker 12, the position of each characteristic point F1 in the marker front-view coordinate system, the coordinate calculator 22 calculates the homography matrix that enables projective transformation of the coordinates of the characteristic points F1 in the image coordinate system to those in the marker front-view coordinate system. This projective transformation enables calibration of a deviation between the viewing orientation of the front camera 11 and the viewing orientation defined in the marker front-view coordinate system.

The coordinate calculator 22 can use one of known homography-matrix calculation methods, such as a method of performing iterative calculations of homography matrix candidates to select an optimized one of the homography matrix candidates as the homography matrix or a method of calculating the homography matrix using the least square method.

The following describes, as an example, the method of calculating the homography matrix using the least square method.

First, the method uses the following homography transformation formulas [1] to [4] to transform the coordinates of any standardized characteristic point F1 into true coordinates, i.e., true x- and y-coordinates, of the corresponding standardized characteristic point (see F2 in FIG. 6) in the marker front-view coordinate system:

$${P}_{i}^{′} = H \cdot {P}_{i}^{T} \qquad [ 1 ]$$

$${P}_{i} = ( {x}_{i} , {y}_{i} , 1 ) \qquad [ 2 ]$$

$${P}_{i}^{′} = ( {x}_{i}^{′} , {y}_{i}^{′} , 1 ) \qquad [ 3 ]$$

$$H = [ \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ] \qquad [ 4 ]$$

where:

Pᵢ=(xᵢ, yᵢ, 1) represents extended three-dimensional coordinates of any standardized characteristic point F1 in the image coordinate system;

Pᵢ′=(xᵢ′, yᵢ′, 1) represents extended three-dimensional true coordinates of corresponding standardized characteristic point F2 in the marker front-view coordinate system; and

$$H = [ \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ]$$

represents the homography matrix.

Note that true coordinates of a characteristic point F2 in the marker front-view coordinate system are defined such that, if the corresponding characteristic point F1 in the image coordinate system is correctly transformed to the characteristic point F2 in the marker front-view coordinate system by the homography transformation, the coordinates of the characteristic point F2 in the marker front-view coordinate system accurately matching the corresponding characteristic point F1 in the image coordinate system are determined as true coordinates of the characteristic point F2 in the marker front-view coordinate system.

To express the homography transformation as a clear formula, adding one dimension, which is 1, to the two-dimensional coordinates (xᵢ, yᵢ) enables the extended three-dimensional coordinates (xᵢ, yᵢ, 1) to be obtained. This can be applied to the extended three-dimensional coordinates (xᵢ′, yᵢ′, 1).

When each of the extended three-dimensional coordinates Pᵢ′=(xᵢ′, yᵢ′, 1) and the extended three-dimensional coordinates Pᵢ=(xᵢ, yᵢ, 1) is represented as a vector, because the vector P′ and the vector H*Pᵢ^{T} are parallel to each other, the cross product of the vector P′ and the vector H*Pᵢ^{T} becomes zero, which is represented by the following formula [5]:

$${P}_{i}^{′} \times H * {P}_{i}^{T} = 0 \qquad [ 5 ]$$

The homograph matrix H has scale invariance. That is, even if each of the elements h₁ to h₀ is multiplied by any constant, each of the elements h₁ to h₀ is invariant. For this reason, in order to reduce the nine degrees of freedom of the homograph matrix H, the homograph matrix H is restricted so that the ninth element h, of the homograph matrix H is set to 1. Thereafter, the above formula [5] is expanded so that the following formula [6] is obtained:

$$[ \begin{matrix}0 & 0 & 0 & - {x}_{i} & - {y}_{i} & - 1 & {y}_{i}^{′} {x}_{i} & {y}_{i}^{′} {y}_{i} & {y}_{i}^{′} \\ {x}_{i} & {y}_{i} & 1 & 0 & 0 & 0 & - {x}_{i}^{′} {x}_{i} & - {x}_{i}^{′} {y}_{i} & - {x}_{i}^{′} \\ ⋮ & ⋮ & ⋮ & ⋮ & ⋮ & ⋮ & ⋮ & ⋮ & ⋮ \\ 0 & 0 & 0 & - {x}_{i} & - {y}_{i} & - 1 & {y}_{i}^{′} {x}_{i} & {y}_{i}^{′} {y}_{i} & {y}_{i}^{′} \\ {x}_{i} & {y}_{i} & 1 & 0 & 0 & 0 & - {x}_{i}^{′} {x}_{i} & - {x}_{i}^{′} {y}_{i} & - {x}_{i}^{′}\end{matrix} ] [ \begin{matrix}{h}_{1} \\ {h}_{2} \\ {h}_{3} \\ {h}_{4} \\ {h}_{5} \\ {h}_{6} \\ {h}_{7} \\ {h}_{8} \\ 1\end{matrix} ] = 0 \qquad [ 6 ]$$

Assuming that the left-side coefficient matrix of the formula [6] is represented as A and the components of the homography matrix are represented as a column vector h, the following formula [7] is satisfied:

$$Ah = 0 \qquad [ 7 ]$$

Assigning the formula [7] to the least square method enables the following formula [8] to be obtained:

$$J = \frac{1}{2} {h}^{T} {A}^{T} Ah \to min \qquad [ 8 ]$$

where:

J represents a function that should be minimized; and

the symbol “→min” represents that the function] should be minimized.

When the column vector h is an eigenvector corresponding to a minimal eigenvalue of the matrix A^{T}A, the function h^{T}A^{T} Ah becomes minimum.

Singular value decomposition of the matrix A enables the eigenvector corresponding to the minimal eigenvalue of the matrix A^{T}A to be calculated. This results in the homograph matrix H being calculated.

After completion of calculating the homograph matrix H, the coordinate calculator 22 multiplies, for each target marker 12, the standardized coordinates of each of the five characteristic points F1 in the image coordinate system (see FIG. 5) by the homograph matrix H to accordingly calculate, for the corresponding target marker 12, projective-transformed coordinates of the corresponding one of the five characteristic points F2 (see FIG. 6). That is, the coordinate calculator 22 calculates, for each target marker 12, the coordinates of the corresponding one of the five characteristic points F2 in the marker front-view coordinate system. This results in the coordinates of each characteristic point F1 in the image coordinate system included in the frame image captured by the front camera 11 being transformed to the coordinates of the corresponding characteristic point F2 in the marker front-view coordinate system.

The coordinate calculator 22 therefore acquires a positional relationship among the coordinates of the characteristic points F2 in the marker front-view coordinate system; the coordinates of the characteristic points F2 in the marker front-view coordinate system are illustrated in FIG. 6.

The marker identifier 23 is configured to calculate, for each target marker 12, (I) an absolute x-coordinate deviation of the x-coordinate of each characteristic point F2 in the marker front-view coordinate system from the true x-coordinate of the corresponding characteristic point F2 in the marker front-view coordinate system and (II) an absolute y-coordinate deviation of the y-coordinate of each characteristic point F2 in the marker front-view coordinate system from the true y-coordinate of the corresponding characteristic point F2 in the marker front-view coordinate system. Then, the marker identifier 23 is configured to determine, for each target marker 12, whether a detection accuracy of each characteristic point F2 is lower than a reference detection-accuracy requirement in accordance with the calculated absolute x- and y-coordinate deviations of each characteristic point F2 in the marker front-view coordinate system.

In accordance with the results of the determination of whether the detection accuracy of each characteristic point F2 for each target marker 12 is lower than the reference detection-accuracy requirement, the marker identifier 23 is configured to identify at least one target marker 12, which includes at least one characteristic point F2 having the detection accuracy lower than the reference detection-accuracy requirement.

For example, the marker identifier 23 is configured to determine, for each target marker 12, whether each of the calculated absolute x- and y-coordinate deviations of each characteristic point F2 in the marker front-view coordinate system is greater than a predetermined deviation threshold. Then, the marker identifier 23 is configured to determine, for each target marker 12, that the detection accuracy of at least one characteristic point F2 is lower than the reference detection-accuracy requirement upon determination that at least one of the calculated absolute x- and y-coordinate deviations of the at least one characteristic point F2 in the marker front-view coordinate system is greater than the predetermined deviation threshold.

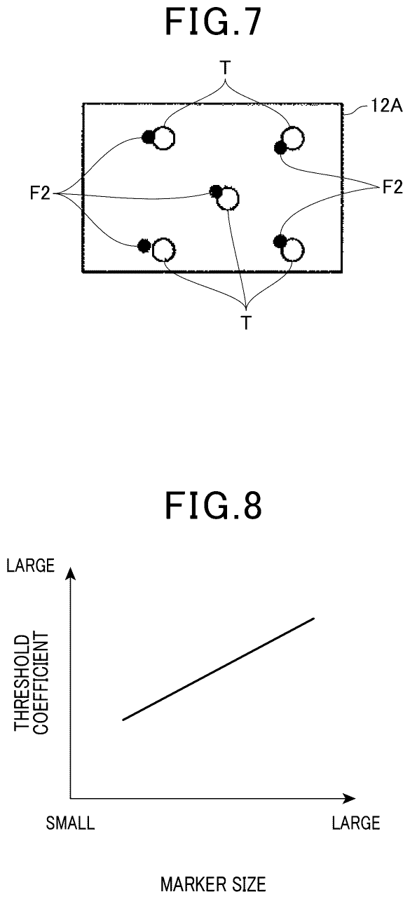

For example, FIG. 7 illustrates, by white circular symbols T, the true x- and y-coordinates of the corresponding projective-transformed characteristic point. Specifically, FIG. 7 shows that the coordinates of each characteristic point F2 (see black circular symbols) are deviated from the true coordinates T of the corresponding characteristic point F2. This deviation of each characteristic point F2 may result from a detection error of the corresponding characteristic point F2, i.e., the corresponding characteristic point F1 in the image coordinate system. The detection error of each characteristic point F1 in the image coordinate system may cause the corresponding characteristic point F1, which has been subjected to the homography transformation accurately, to be transformed to the position deviating from the corresponding true position, resulting in an increase in at least one of the calculated absolute x- and y-coordinate deviations of at least one characteristic point F2 in the marker front-view coordinate system being greater than the predetermined deviation threshold.

Accordingly, the marker identifier 23 determines, for each target marker 12, that the detection accuracy of at least one characteristic point F2 is lower than the reference detection-accuracy requirement upon determination that at least one of the calculated absolute x- and y-coordinate deviations of the at least one characteristic point F2 in the marker front-view coordinate system is greater than the predetermined deviation threshold.

More specifically, for each target marker 12, the marker identifier 23 is configured to calculate an x-coordinate root mean square of the absolute x-coordinate deviations, each of which is the deviation of the x-coordinate of the corresponding characteristic point F2 in the marker front-view coordinate system from the true x-coordinate of the corresponding characteristic point F2 in the marker front-view coordinate system.

Additionally, for each target marker 12, the marker identifier 23 is configured to calculate a y-coordinate root mean square of the absolute y-coordinate deviations, each of which is the deviation of the y-coordinate of the corresponding characteristic point F2 in the marker front-view coordinate system from the true y-coordinate of the corresponding characteristic point F2 in the marker front-view coordinate system.

The x-coordinate root mean square will be referred to as an x-coordinate guard index, and the y-coordinate root mean square will be referred to as a y-coordinate guard index.

As the size of the corresponding target marker 12 in the frame image decreases so that the resolution of the corresponding target marker 12 decreases, the accuracy of each of the x- and y-coordinate guard indexes calculated for each target marker 12 is likely to decrease.

From this viewpoint, to smooth the discrimination capabilities of the x-coordinate guard indexes of the target markers 12 and the discrimination capabilities of the y-coordinate guard indexes of the target markers 12, the threshold determiner 26 according to the exemplary embodiment is configured to determine, for each target marker 12, a guard threshold as the predetermined deviation threshold depending on the size of the corresponding target marker 12 in the frame image.

FIG. 8 illustrates an example of a relationship between the variable of a threshold coefficient and the size of each target marker 12. The relationship shows that, the smaller the size of each target marker 12, the smaller the threshold coefficient. The ECU 20 can include the relationship stored in the memory device or include the relationship as data in a parameter estimating program stored in the memory device.

Specifically, the threshold determiner 26 can be configured to calculate, for each target marker 12, the guard threshold using the relationship illustrated as an example in FIG. 8.

The ECU 20 can include the relationship stored in the memory device or include the relationship as data in a parameter estimating program stored in the memory device.

Additionally, the ECU 20 includes a base threshold defined as an allowable deviation of each of the x- and y coordinates of each characteristic point F2 from the corresponding one of the true x- and y-coordinates of the corresponding characteristic point F2. The base threshold can be stored in the memory device or included as data in the parameter estimating program stored in the memory device.

That is, for each target marker 12, the threshold determiner 26 can be configured to refer to the relationship using the size of the corresponding target marker 12 to accordingly retrieve a value of the threshold coefficient corresponding to the size of the corresponding target marker 12. Then, the threshold determiner 26 can be configured to multiply, for each target marker 12, the base threshold by the retrieved value of the threshold coefficient to accordingly determine the guard threshold for the corresponding target marker 12.

Specifically, for each target marker 12, the marker identifier 23 is configured to compare
(I) The x-coordinate guard index calculated for each characteristic point F2 indicative of the deviation of the x-coordinate of the corresponding characteristic point F2 from the true x-coordinate of the corresponding characteristic point F2 with the guard threshold determined for the corresponding target marker 12
(II) The y-coordinate guard index i calculated for each characteristic point F2 indicative of the deviation of the y-coordinate of the corresponding characteristic point F2 from the true y-coordinate of the corresponding characteristic point F2 with the guard threshold determined for the corresponding target marker 12

Then, the marker identifier 23 is configured to determine that the detection accuracy of each characteristic point F2 arranged on each target marker 12 is higher than or equal to the reference detection-accuracy requirement upon determination that (i) the x-coordinate guard index calculated for the corresponding characteristic point F2 is smaller than or equal to the guard threshold determined for the corresponding target marker 12 and (ii) the y-coordinate guard index calculated for the corresponding characteristic point F2 is smaller than or equal to the guard threshold determined for the corresponding target marker 12.

In contrast, the marker identifier 23 is configured to determine that the detection accuracy of at least one characteristic point F2 arranged on at least one target marker 12 is lower than the reference detection-accuracy requirement upon determination that (i) the x-coordinate guard index calculated for the at least one characteristic point F2 is larger than the guard threshold determined for the at least one target marker 12 or (ii) the y-coordinate guard index calculated for the at least one characteristic point F2 is larger than the guard threshold determined for the at least one target marker 12.

Then, the marker identifier 23 is configured to identify the at least one target marker 12 including the at least one characteristic point F2 whose detection accuracy is lower than the reference detection-accuracy requirement.

That is, the ECU 20 performs, as described above, a precise recognition determination task for the front camera 11, which is configured to
(I) Determine, for each target marker 12, whether precise recognition of the corresponding target marker 12 by the front camera 11 is carried out in accordance with the detection-accuracy determination result of each characteristic point F arranged on the corresponding target marker 12
(II) Identify, based on the determination results, at least one target marker 12 if it is determined that the precise recognition of the at least one target marker 12 by the front camera 11 is not carried out, thus identifying the remaining one or more target markers 12, precise recognition of which by the front camera 12 are carried out

The parameter estimator 24 is configured to estimate optimum values of the respective parameters of the front camera 11 in accordance with the x- and y-coordinates of each of the five characteristic points F2 arranged on all the target markers 12 in the marker front-view coordinate system upon determination that the detection accuracy of each of the five characteristic points F2 arranged on all the target markers 12 is higher than or equal to the reference detection-accuracy requirement.

Specifically, the parameter estimator 24 is configured to transform, for each target marker 12, the x- and y-coordinates of each of the five characteristic points F2 in the marker front-view coordinate system into coordinates of the corresponding one of the five characteristic points F2 in a predetermined world coordinate system defined for the front camera 11, i.e., coordinates of the corresponding one of the five characteristic points F2 on the real space around the vehicle 10. Then, the parameter estimator 24 is configured to calculate, for each target marker 12, absolute deviations between the coordinates of each characteristic point F2 in the predetermined world coordinate system and the corresponding designed coordinates of the corresponding characteristic point F2 in the predetermined world coordinate system. Accordingly, the parameter estimator 24 is configured to use, as evaluation scores, the absolute deviations between the coordinates of each characteristic point F2 in the predetermined world coordinate system and the corresponding designed coordinates of the corresponding characteristic point F2 in the predetermined world coordinate system to accordingly determine values of the respective parameters of the front camera 11 to accordingly calibrate the front camera 11; the values of the respective parameters of the front camera 11 enable the evaluation scores to be minimized

The world coordinate system defined for the front camera 11 can be for example defined to have (i) an origin located at any position in the real space around the vehicle 10, such as the center of the front of the vehicle 10, (ii) a Z axis passing through the origine and extending perpendicularly to the road surface on which the vehicle 10 is located, (iii) an X-axis, which is perpendicular to the Z axis, passing through the origine and extending in the width direction of the vehicle 10, and (iv) a Y axis, which is perpendicular to the X and Z axes, passing through the origine and extending in the longitudinal direction of the vehicle 10.

The parameters of each camera 11 show the mount position of the corresponding camera 11, the direction of the optical axis of the corresponding camera 11, and the other various information items related to the corresponding camera 11. More specifically, the parameters of each camera 11 include, for example, X-, Y-, and Z-coordinates of the position of the corresponding camera 11 in the world coordinate system, roll, pitch, and yaw angles of the corresponding camera 11, and distortion of the lens system of the corresponding camera 11. The roll angle of each camera 11 specifies the angle of rotation around the optical axis of the corresponding camera 11. That is, adjustment of the roll angle of each camera 11 changes a frame image captured by the corresponding camera 11. The yaw angle of each camera 11 specifies an angle of rotation around an axis parallel to the vertical direction. That is, adjustment of the yaw angle of each camera 11 changes the image capture orientation, i.e., the viewing orientation, of the corresponding camera 11 horizontally. The pitch angle of each camera 11 specifies an angle of rotation around a horizontal axis parallel to the horizontal direction. That is, adjustment of the pitch angle of each camera 11 changes the image capture orientation, i.e., the viewing orientation, of the corresponding camera 11 vertically.

In contrast, let us consider a case where the marker identifier 23 identifies, as a low-accuracy target marker 12, one target marker 12 including the at least one characteristic point F2 whose detection accuracy is lower than the reference detection-accuracy requirement.

In this case, the parameter estimator 24 is configured to exclude, from the target markers 12, the low-accuracy target marker 12. Then, the parameter estimator 24 is configured to estimate the values of the respective parameters of the front camera 11 in accordance with the x- and y-coordinates of each of the characteristic points F2 in the marker front-view coordinate system arranged on the remaining target markers 12 other than the low-accuracy target marker 12 to accordingly calibrate the front camera 11.

The notifying unit 25 is configured to notify identification information on the target markers 12 included in the frame image captured by the front camera 11 to the outside of the ECU 20. For example, when one target marker 12 included in the frame image captured by the front camera 11 is determined as the low-accuracy target marker 12, the notifying unit 25 is configured to notify, to one or more external devices, information indicative of whether precise recognition of each target marker 12 included in the frame image captured by the front camera 11 is carried out. The one or more external devices may include output devices for visibly and/or audibly outputting information and/or a management device that manages manufacturing of the cameras 11 in the factory can be used.

The information notified by the notifying unit 25 can include, about a target marker 12 whose precise recognition has failed, information indicative of why precise recognition of the target marker 12 has failed. This can prompt an operator to improve recognition of the target marker 12 whose precise recognition has failed. The information notified by the notifying unit 25 can include, about a target marker 12 whose precise recognition has failed, information including the validity of arrangement of the target markers 12 and/or suggestions for improvement to an operator, such as rearrangement of the target markers 12. The notifying unit 25 can be configured to calculate a detection-accuracy index based on the specifications of the vehicle 10 and the arrangement of the target markers 12, and notify, to one or more external devices, the calculated detection-accuracy index. Additionally, the notifying unit 25 can be configured to calculate information on quantified detection-failure risks of the target markers 12, and notify, to one or more external devices, the calculated information. The notifying unit 25 can be configured to calculate information on quantified reliability of estimation of the parameters of the front camera 11, such as the determinant of the homography matrix as a measure of the reliability, and notify, to one or more external devices, the calculated information.

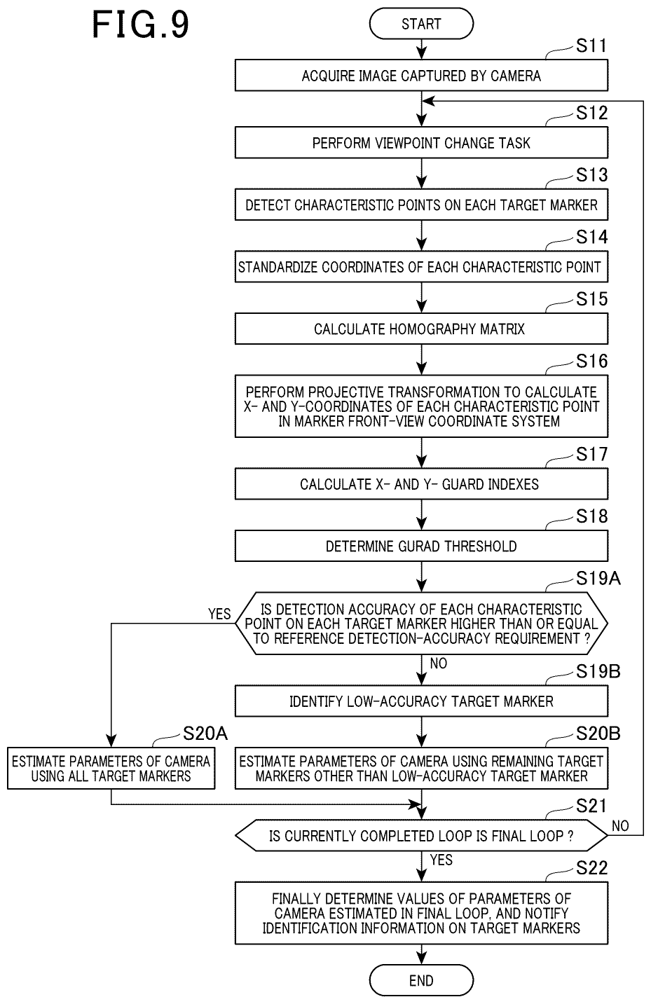

FIG. 9 is a flowchart schematically illustrating a parameter estimating routine. The ECU 20 is programmed to execute, in accordance with instructions of the parameter estimating program stored in the memory device, the parameter estimating routine every predetermined period during a calibration process of, for example, the front camera 11, included in the manufacturing processes of the vehicle 10. In particular, the parameter estimating routine includes a loop, i.e., a sequence of operations, that is repeated predetermined times for estimating values of the parameters of the front camera 11.

When starting the parameter estimating routine, the ECU 20 captures a frame image captured by the front camera 11 in step S11.

Following the operation in step S11, the ECU 20 performs a loop of the operations in steps S12 to S20A or S20B described later.

Specifically, in step S12, the ECU 20 performs a viewpoint change task of changing the viewpoint of an image region of each target marker 12 in the frame image based on installation information on the front camera 11 and arrangement information on the target markers 12 included in the frame image captured by the front camera 11 to accordingly cause each target marker 12 to appear to be in direct front of the front camera 11, i.e., to accordingly cause the target markers 12 to be in size and orientation alignment with one another. The installation information on the front camera 11 and the arrangement information on the target markers 12 included in the frame image captured by the front camera 11 are stored beforehand in the memory device of the ECU 20. The installation information on the front camera 11 may include, for example, the mount position of the front camera 11 to the vehicle 10 as the coordinates of the world coordinate system.

For example, the ECU 20 performs, as the viewpoint change task, an increase in size of the image region of at least one target marker 12, a decrease in size of the image region of at least one target marker 12, and/or rotation of the image region of at least one target marker 12.

Following the operation in step S12, the ECU 20 serves as, for example, the characteristic point detector 21 to detect the characteristic points F on each target marker 12 included in the frame image captured by the front camera 11 (see FIG. 4) in step S13.

Next, the ECU 20 serves as, for example, the coordinate calculator 22 to standardize, for each target marker 12, the coordinates of each characteristic point F in the image coordinate system to accordingly acquire, for each target marker 12, a standardized characteristic point F1 in the image coordinate system in step S14 (see FIG. 5).

Following the operation in step S14, the ECU 20 serves as, for example, the coordinate calculator 22 to calculate the homography matrix used to perform projective transformation, i.e., homography transformation in step S15.

Next, the ECU 20 serves as, for example, the coordinate calculator 22 to multiply, for each target marker 12, the standardized coordinates of each of the five characteristic points F1 in the image coordinate system (see FIG. 5) by the homograph matrix H to accordingly calculate, for the corresponding target marker 12, projective-transformed coordinates of the corresponding one of five characteristic points F2 in the marker front-view coordinate system in step S16 (see FIG. 6).

Following the operation in step S16, the ECU serves as, for example, the marker identifier 23 to calculate, for each target marker 12, the x-coordinate root mean square of the absolute x-coordinate deviations, each of which is the deviation of the x-coordinate of the corresponding characteristic point F2 in the marker front-view coordinate system from the true x-coordinate of the corresponding characteristic point F2 in the marker front-view coordinate system in step S17; the x-coordinate root mean square is defined as the x-coordinate guard index.

Additionally, the ECU 20 serves as, for example, the marker identifier 23 to calculate, for each target marker 12, a y-coordinate root mean square of the absolute y-coordinate deviations, each of which is the deviation of the y-coordinate of the corresponding characteristic point F2 in the marker front-view coordinate system from the true y-coordinate of the corresponding characteristic point F2 in the marker front-view coordinate system in step S17; the y-coordinate root mean square is defined as the y-coordinate guard index.

Following the operation in step S17, the ECU 20 serves as, for example, the threshold determiner 26 to determine, for each target marker 12, the guard threshold used to compare each of the x- and y-coordinate guard indexes in step S18. Preferably, the ECU 20 serves as, for example, the threshold determiner 26 to determine, for each target marker 12, the guard threshold depending on the size of the corresponding target marker 12 in the frame image.

Next, the ECU 20 serves as, for example, the marker identifier 23 to compare the x-coordinate guard index calculated for each characteristic point F2 with the guard threshold determined for the corresponding target marker 12, and compare the y-coordinate guard index calculated for each characteristic point F2 with the guard threshold determined for the corresponding target marker 12 in step S19A.

Then, the ECU 20 serves as, for example, the marker identifier 23 to determine, based on the results of the comparison, whether the detection accuracy of each characteristic point F2 arranged on each target marker 12 is higher than or equal to the reference detection-accuracy requirement in step S19A.

In step S19A, the ECU 20 serves as, for example, the marker identifier 23 to determine that the detection accuracy of each characteristic point F2 arranged on each target marker 12 is higher than or equal to the reference detection-accuracy requirement upon determination that (i) the x-coordinate guard index calculated for the corresponding characteristic point F2 is smaller than or equal to the guard threshold determined for the corresponding target marker 12 and (ii) the y-coordinate guard index calculated for the corresponding characteristic point F2 is smaller than or equal to the guard threshold determined for the corresponding target marker 12 (YES in step S19A). Then, the parameter estimating routine proceeds to step S20A.

Otherwise, the ECU 20 serves as, for example, the marker identifier 23 to determine that at least one characteristic point F2 arranged on at least one target marker 12 is lower than the reference detection-accuracy requirement upon determination that (i) the x-coordinate guard index calculated for the at least one characteristic point F2 is larger than the guard threshold determined for the at least one target marker 12 or (ii) the y-coordinate guard index calculated for the at least one characteristic point F2 is larger than the guard threshold determined for the at least one target marker 12 (NO in step S19A). Then, the parameter estimating routine proceeds to step S19B.

In step S19B, the ECU 20 serves as, for example, the marker identifier 23 to identify, as at least one low-accuracy target marker 12, the at least one target marker 12 including the at least one characteristic point F2 whose detection accuracy is lower than the reference detection-accuracy requirement. Thereafter, the parameter estimating routine proceeds to step S20B.

Following the operation in step S19A, the ECU 20 serves as, for example, the parameter estimator 24 to estimate values of the respective parameters of the front camera 11 in accordance with the x- and y-coordinates of each of the five characteristic points F2 arranged on all the target markers 12 in the marker front-view coordinate system in step S20A.

In contrast, following the operation in step S19B, the ECU 20 serves as, for example, the parameter estimator 24 to exclude, from the target markers 12, the low-accuracy target marker 12 in step S20B. Then, the ECU 20 serves as, for example, the parameter estimator 24 to estimate the values of the respective parameters of the front camera 11 in accordance with the x- and y-coordinates of each of the characteristic points F2 in the marker front-view coordinate system arranged on the remaining target markers 12 other than the low-accuracy target marker 12 in step S20B.

After the operation in step S20A or S20B, the ECU 20 determines that the loop of the operations in steps S12 to S20A or S20B is completed. Then, the parameter estimating routine proceeds to step S21.

In step S21, the ECU 20 serves as, for example, the parameter estimator 24 to determine whether the currently completed loop is a final loop, that is, the number of repeated execution of the loop has reached the predetermined times.

Upon determination that currently completed loop is not the final loop (NO in step S21), the ECU 20 returns to step S12, and repeats the loop of the operations in steps S12 to S20A or S20B set forth above.

Otherwise, upon determination that currently completed loop is the final loop (YES in step S21), the parameter estimating routine proceeds to step S22.

In step S22, the ECU 20 serves as, for example, the parameter estimator 24 to finally determine the values of the parameters of the front camera 11 estimated in the final loop as optimum values of the respective parameters of the front camera 11 . . . .

In step S22, the ECU 20 serves as, for example, the notifying unit 25 to notify identification information on the target markers 12 included in the frame image captured by the front camera 11 to, for example, one or more external devices, and thereafter, the ECU 20 terminates the parameter estimating routine. The identification information on the target markers 12 represents whether the target markers 12 included in the frame image captured by the front camera 11 include at least one low-accuracy target marker 12. In step S22, the ECU 20 can serve as, for example, the notifying unit 25 to notify, to the one or more external devices, the finally determined optimum values of the parameters of the front camera 11.

In step S22, the ECU 20 can store the identification information on the target markers 12 in the memory device or a backup memory installed in the ECU 20.

As described above, the ECU 20, which serves as a camera parameter estimating apparatus, achieves the following advantageous benefits.

The ECU 20 is configured to compare, for each target marker 12 included in an image captured by the front camera 11, projective-transformed coordinates of each characteristic point F2 arranged on the corresponding target marker 12 with true coordinates of the corresponding characteristic point F2 to accordingly determine whether the detection accuracy of each characteristic point F2 is lower than the reference detection-accuracy requirement.

The ECU 20 is configured to identify a selected target marker 12 as a low-accuracy target marker 12 upon determination that the detection accuracy of at least one characteristic point F2 arranged on the selected target marker 12 is lower than the reference detection-accuracy requirement.

Then, the ECU 20 is configured to exclude, from the target markers 12 included in the image captured by the front camera 11, the low-accuracy target marker 12, and estimate values of the parameters of the front camera 11 in accordance with the coordinates of each characteristic point F2 arranged on the remaining target markers 12 other than the low-accuracy target marker 12.

This configuration therefore makes it possible to determine whether each target marker 12 is suitable for being used in estimation of the parameters of the front camera 11, and to use only one or more target markers 12 suitable for being used in estimation of the parameters of the front camera 11. This results in the accuracy of estimating the parameters of the front camera 11 being higher.

Even if it is determined that the detection accuracy of at least one characteristic point F2 included in some target markers 12 is lower than the reference detection-accuracy requirement, the ECU 20 enables estimation of the parameters of the front camera 11 using the remaining target markers 12, making it possible to improve the estimation efficiency of the parameters of the front camera 11. This enables the parameters of the front camera 11 to be more precisely estimated.

The ECU 20 is configured to perform, using the homography matrix, projective transformation of the coordinates of each characteristic point in the image coordinate system to those in the marker front-view coordinate system. This configuration enables the position of each characteristic point F2 of each target marker 12 in the marker front-view coordinate system to be precisely achieved, making it possible to precisely determine whether there is a detection error in each characteristic point F2, resulting in the accuracy of estimating the parameters of the front camera 11 being higher.

The resolution of each target marker 12 included in an image captured by the front camera 11 changes depending on the size of the corresponding target marker 12.

From this viewpoint, the ECU 20 is configured to calculate, for each target marker 12, (I) an absolute x-coordinate deviation of the x-coordinate of each characteristic point F2 in the marker front-view coordinate system from the true x-coordinate of the corresponding characteristic point F2 in the marker front-view coordinate system and (II) an absolute y-coordinate deviation of the y-coordinate of each characteristic point F2 in the marker front-view coordinate system from the true y-coordinate of the corresponding characteristic point F2 in the marker front-view coordinate system.

Then, the ECU 20 is configured to determine, for each target marker 12, whether each of the calculated absolute x- and y-coordinate deviations of each characteristic point F2 in the marker front-view coordinate system is greater than the predetermined deviation threshold.

In particular, the ECU 20 is configured to determine the predetermined deviation threshold in accordance with the size of each target marker 12 included in an image captured by the front camera 11.

This configuration makes it possible to smooth the discrimination capabilities of the characteristic points F2 arranged on the target markers 12 even if the sizes of some target markers 12 are different from one another.

As described above, the ECU 20 is configured to exclude, from the target markers 12 included in an image captured by the front camera 11, a low-accuracy target marker 12 upon determination that the detection accuracy of at least one characteristic point F2 arranged on the low-accuracy target marker 12 is lower than the reference detection-accuracy requirement due to, for example, the quality of the image and/or installation errors of the front camera 11 to the vehicle 10. Then, the ECU 20 is configured to estimate values of the parameters of the front camera 11 in accordance with the coordinates of each characteristic point F2 arranged on the remaining target markers 12 other than the low-accuracy target marker 12.

Additionally, the ECU 20 is configured to notify, to one or more external devices, identification information on the target markers 12 representing whether the target markers 12 included in the image captured by the front camera 11 include at least one low-accuracy target marker 12.

This configuration makes it possible to prompt an operator to improve positioning of at least one low-accuracy target marker during a calibration process of, for example, the front camera 11 if the identification information represents that the target markers 12 included in the image captured by the front camera 11 include the at least one low-accuracy target marker 12.

Until now, we have described how the ECU 20, which serves as a camera parameter estimating apparatus, estimates the parameters of the front camera 11, and how the ECU 20 achieves the advantageous benefits related to estimation of the parameters of the front camera 11, but the present disclosure is not limited thereto.

Specifically, the ECU 20, which serves as a camera parameter estimating apparatus, can estimate the parameters of each of the remaining cameras 11 other than the front camera 11 in the same manner as the front camera 11, and can achieve the advantageous benefits related to estimation of the parameters of the each of the remaining cameras 11, which are the same as those stated for the front camera 11.

### Modifications

While the exemplary embodiment of the present disclosure has been described above, the present disclosure is not limited to the exemplary embodiment. Specifically, the present disclosure includes various modifications and/or alternatives of the exemplary embodiment within the scope of the present disclosure.

The above exemplary embodiment is configured to perform homography transformation as the projective transformation, but can perform one of the other known transformation methods as the projective transformation as long as the used one of the other known transformation methods can transform the position of each characteristic point arranged on at least one target marker 12 in a predetermined coordinate system included in an image captured by each camera 11 to a position thereof in a front-view coordinate system defined as a coordinate system viewed, i.e., observed, from the direct front of the corresponding characteristic point.

The above exemplary embodiment describes estimation of parameters of each camera 11 mounted to the vehicle 10, but the present disclosure is not limited thereto. Specifically, the present disclosure can perform estimation of parameters of a camera mounted to a physical mobile object, such as an aircraft or a ship. Additionally, the present disclosure can perform estimation of parameters of a camera mounted to a physical stationary object.

The parameter estimating apparatuses and methods described in the present disclosure can be implemented by a dedicated computer including a memory and a processor programmed to perform one or more functions embodied by one or more computer programs.

The parameter estimating apparatuses and methods described in the present disclosure can also be implemented by a dedicated computer including a processor comprised of one or more dedicated hardware logic circuits.

The parameter estimating apparatuses and methods described in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor.

1. A camera parameter estimating apparatus for estimating, based on an image captured by a camera mounted to a physical object, at least one parameter of the camera, the image including a plurality of target markers located at respective different positions of the image, each target marker including a plurality of characteristic points arranged thereon, the camera parameter estimating apparatus comprising:
a characteristic point detector configured to detect the characteristic points arranged on each target marker included in the image;
a coordinate calculator configured to:
perform, for each target marker, projective transformation of each characteristic point arranged on the corresponding target marker in a predetermined coordinate system to the corresponding characteristic point in a front-view coordinate system; and
calculate an x-coordinate and a y-coordinate of each characteristic point in the front-view coordinate system;
a marker identifier configured to:
compare, for each target marker, the x- and y-coordinates of each characteristic point in the front-view coordinate system with true x- and y-coordinates of the corresponding characteristic point in the front-view coordinate system to accordingly determine whether a detection accuracy of each characteristic point is lower than a reference detection-accuracy requirement; and
identify, as a low-accuracy target marker, a selected target marker from the target markers upon determination that the detection accuracy of at least one characteristic point arranged on the selected target marker is lower than the reference detection-accuracy requirement; and
a parameter estimator configured to:
estimate the at least one parameter of the camera in accordance with the x- and y-coordinates of each characteristic point arranged on one or more remaining target markers included in the image other than the low-accuracy target marker.

2. The camera parameter estimating apparatus according to claim 1, wherein:
the coordinate calculator configured to perform, for each target marker, the projective transformation using a homography matrix.

3. The camera parameter estimating apparatus according to claim 1, wherein:
the marker identifier is configured to:
calculate, for each target marker,
an absolute x-coordinate deviation of the x-coordinate of each characteristic point in the front-view coordinate system from the true x-coordinate of the corresponding characteristic point in the front-view coordinate system; and
an absolute y-coordinate deviation of the y-coordinate of each characteristic point in the front-view coordinate system from the true y-coordinate of the corresponding characteristic point in the front-view coordinate system; and
determine, for each target marker, whether each of the calculated absolute x- and y-coordinate deviations of each characteristic point in the front-view coordinate system is greater than a deviation threshold to accordingly determine whether the detection accuracy of each characteristic point is lower than the reference detection-accuracy requirement,
the camera parameter estimating apparatus further comprising:
a threshold determiner configured to determine, for each target marker, the deviation threshold in accordance with a size of the corresponding target marker included in the image.

4. The camera parameter estimating apparatus according to claim 1, further comprising:
a notifying unit configured to notify, to one or more external devices, identification information on the target markers included in the image, the identification information representing whether the target markers included in the image include the low-accuracy target marker.

5. A program product for estimating, based on an image captured by a camera mounted to a physical object, at least one parameter of the camera, the image including a plurality of target markers located at respective different positions of the image, each target marker including a plurality of characteristic points arranged thereon, the program product comprising:
a non-transitory storage medium that stores computer-program instructions,
the computer-program instructions causing a processor to:
detect the characteristic points arranged on each target marker included in the image;
perform, for each target marker, projective transformation of each characteristic point arranged on the corresponding target marker in a predetermined coordinate system to the corresponding characteristic point in a front-view coordinate system;
calculate an x-coordinate and a y-coordinate of each characteristic point in the front-view coordinate system;
compare, for each target marker, the x- and y-coordinates of each characteristic point in the front-view coordinate system with true x- and y-coordinates of the corresponding characteristic point in the front-view coordinate system to accordingly determine whether a detection accuracy of each characteristic point is lower than a reference detection-accuracy requirement;
identify, as a low-accuracy target marker, a selected target marker from the target markers upon determination that the detection accuracy of at least one characteristic point arranged on the selected target marker is lower than the reference detection-accuracy requirement; and
estimate the at least one parameter of the camera in accordance with the x- and y-coordinates of each characteristic point arranged on one or more remaining target markers included in the image other than the low-accuracy target marker.

6. The program product according to claim 5, wherein:
the computer-program instructions cause the processor to perform, for each target marker, the projective transformation using a homography matrix.

7. The program product according to claim 5, wherein:
the computer-program instructions cause the processor to:
calculate, for each target marker,
an absolute x-coordinate deviation of the x-coordinate of each characteristic point in the front-view coordinate system from the true x-coordinate of the corresponding characteristic point in the front-view coordinate system; and
an absolute y-coordinate deviation of the y-coordinate of each characteristic point in the front-view coordinate system from the true y-coordinate of the corresponding characteristic point in the front-view coordinate system;
determine, for each target marker, whether each of the calculated absolute x- and y-coordinate deviations of each characteristic point in the front-view coordinate system is greater than a deviation threshold to accordingly determine whether the detection accuracy of each characteristic point is lower than the reference detection-accuracy requirement; and
determine, for each target marker, the deviation threshold in accordance with a size of the corresponding target marker included in the image.

8. The program product according to claim 5, wherein:
the computer-program instructions cause the processor to notify, to one or more external devices, identification information on the target markers included in the image, the identification information representing whether the target markers included in the image include the low-accuracy target marker.
